(19) United States
(12) Patent Application Publication
(10) Pub. No.: US 2020/0048127 A1
(43) Pub. Date: Feb. 13, 2020

(54) A CONTAINER ARRANGEMENT FOR FISH FARMING

(71) Applicant: Richard Rognsøy, Torshavn (FO)

(72) Inventor: Richard Rognsøy, Torshavn (FO)

(21) Appl. No.: 16/485,611

(22) PCT Filed: Feb. 13, 2018
(86) PCT No.: PCT/NO2018/050039

§ 371 Date: Aug. 13, 2019

(30) Foreign Application Priority Data
Feb. 14, 2017 (NO) 20170219
May 9, 2017 (NO) 20170759

(51) Int. Cl. C02F 9/00; B01D 19/00; B01D 33/06; A01K 63/04

(52) U.S. Cl. CPC C02F 9/00; B01D 19/0042; C02F 1/20; A01K 63/045; A01K 63/042; B01D 33/06

(57) ABSTRACT

A container arrangement is for fish farming and includes a body with a bottom section and a wall section that define a volume adapted to receive water for the fish farming. A water treatment arrangement is for treatment of the water in the container arrangement. The water treatment arrangement has a device for removal of CO2 from the water of the container arrangement including a separation chamber for CO2 and means for separation of CO2 arranged at the chamber. The water treatment arrangement is arranged in the body of the container arrangement.

### INTRODUCTION

The present invention relates to a container arrangement for fish farming where a portion of the water contained within the container is taken out, treated and recycled back into the container. In particular, the invention relates to a container arrangement for land based fish farming. The container arrangement comprises a body comprising a bottom section and a wall section that define a volume adapted to receive water for the fish farming, and a water treatment arrangement for treatment of the water in the container arrangement. The water treatment arrangement comprises a device for removal of CO2 from the water of the container arrangement comprising a separation chamber for CO2 and means for separation of CO2 arranged at said chamber.

### PRIOR ART

Container arrangements for fish farming, which are based on treatment and recycling of the water within the container, are mainly used for land based fish farming. In comparison to sea based fish farming, where the container comprises a net cage that allows water to be exchanged naturally by waves and current, the energy consumption for the treatment and recycling of water in land based fish farming constitutes a significant part of the overall production cost in such container arrangements.

Prior art container arrangements for land based fish farming comprises means for transferring portion of the water to a water treatment arrangement outside the container for treatment of the water, such as for removal of CO2 and particles, and for providing oxygen to the water. Thereafter, the treated water is reintroduced into the container. The treatment of water is normally performed continuously during operation of the container arrangements and involves draining a portion of water and after the treatment of the water pumping the treated portion of the water back up to the container again. A disadvantage with such prior art container arrangements is that the displacement of the water for water treatment is requiring significant energy for the operation of the container arrangement.

Prior art container arrangements for fish farming are also suffering from the disadvantage of being extensive in size and time consuming to set up and dislocate.

### SUMMARY OF THE INVENTION

The invention has for its object to remedy or to reduce at least one of the drawbacks of the prior art, or at least provide a useful alternative to prior art. A first object is to provide an improved container arrangements that requires reduced energy consumption for its operation compared with prior art container arrangements. A second object of the invention is to provide an improved container arrangement that requires less space, and that is faster to set up and dislocate compared with prior art container arrangements.

These objects are achieved by means of a container arrangement for fish farming according to the invention. The container arrangement comprises a body comprising a bottom section and a wall section that define a volume adapted to receive water for the fish farming, and a water treatment arrangement for treatment of the water in the container arrangement, wherein the water treatment arrangement comprises a device for removal of CO2 from the water of the container arrangement comprising a separation chamber for CO2 and means for separation of CO2 arranged at said chamber. The container arrangement is characterized in that the water treatment arrangement is arranged in the body of the container arrangement.

By means of arranging the water treatment arrangement in the body of the container arrangement, the necessary displacement of the portion of water to and from the device for removal of CO2 is reduced. Accordingly, the energy consumption for the operation of the container arrangement is reduced.

Furthermore, by arranging the water treatment arrangement within the body of the container arrangement, the installation of the container arrangement is facilitated compared with prior art container arrangement. Furthermore, the container arrangement can quickly and easily be dislocated from a first location to a second location compared to prior art container arrangements.

According to an embodiment of the invention, wherein the water treatment arrangement is arranged in said wall section of the container arrangement.

The arrangement of water treatment arrangement in the wall section of the container enabling a separation chamber with a large space for the separation means for the CO2 to be provided that allows the portion of water to be displaced through the chamber with at a low flow rate, which facilitates the degassing of CO2 from the portion of the water. Furthermore, by means of the low flow rate of the portion of the water, the energy consumption for displacing the portion of the water through the water treatment arrangement is reduced compared to prior art container arrangements.

According to an embodiment of the invention, the water treatment arrangement comprises an inlet to the separation chamber and an outlet from the separation chamber, which inlet, outlet and separation chamber are arranged at the elevation of said volume defined by the body of the container arrangement.

By means of providing the water treatment arrangement at the elevation of the volume defined by the body of the container arrangement, the portion of the water for treatment may be displaced to the water treatment arrangement without change in elevation, which enables the portion of the water to be displaced for treatment with reduced energy consumption compared to prior art container arrangements.

The term “at the elevation of the volume defined by the body” relates to that the inlet, outlet ant the water treatment arrangement is at the height of the volume of the body, which is to be filled with water.

According to an embodiment of the invention, the inlet, the outlet and separation the chamber for CO2 are arranged within the periphery defined by the body of the container arrangement.

By means of arranging the inlet, outlet and separation chamber within the periphery of the body of the container arrangement, the water treatment arrangement is protected from interaction from the exterior of the container arrangement.

According to an embodiment of the invention, the separation the chamber for CO2 are arranged outside the periphery defined by the body of the container arrangement. By arranging the separation chamber for CO2 outside the body of the container arrangement enables available container arrangement to be modified in a simple manner.

According to an embodiment of the invention, the body of the container arrangement mainly comprises composite material with a strength adapted to contain the water and hold the water treatment device in the body of the container arrangement.

According to an embodiment of the invention, the water treatment arrangement extends along a circumference of said wall section of the body of the container arrangement. According to an embodiment of the invention, the separation chamber of the device for removal of CO2 extends along a circumference of said wall section of the body of the container arrangement. By arranging the water treatment arrangement, and in particular the separation chamber for CO2, along the circumference of the wall section a large area is provided for the degassing of CO2.

According to an embodiment of the invention, the water treatment arrangement comprises two or more devices for removal of CO2 chambers that are located in different parts of the body of the container arrangement. Preferably, the two or more devices comprise respective inlet and outlet from/to the volume of the container arrangement.

According to an embodiment of the invention, the water treatment arrangement comprises a device for removal of solid particles from the water. The device for removal of solid particles is for example a rotary filter device.

According to an embodiment of the invention, the water treatment arrangement comprises means for circulation of water from the inlet to the separation chamber and from the chamber to the outlet and back into the volume of the container arrangement. The means for circulation of water is preferable one or more pump, such as a displacement pump and a centrifugal pump.

According to an embodiment of the invention, the water treatment arrangement comprises a device for providing oxygen to the water.

### BRIEF DESCRIPTION OF DRAWINGS

In the following are examples of preferred embodiments illustrated in the accompanying drawings described, wherein:

FIG. 1A,1B discloses schematic views of a container arrangement for fish farming according to an embodiment of the invention; where:

FIG. 1A discloses the container arrangement in a side view with a cross section along A′-A′ in FIG. 1B;

FIG. 1B discloses the container arrangement in FIG. 1A in a top view.

FIG. 1C-7 discloses different views of a container arrangement for fish farming according to a further embodiment of the invention.

### DETAILED DESCRIPTION OF THE INVENTION

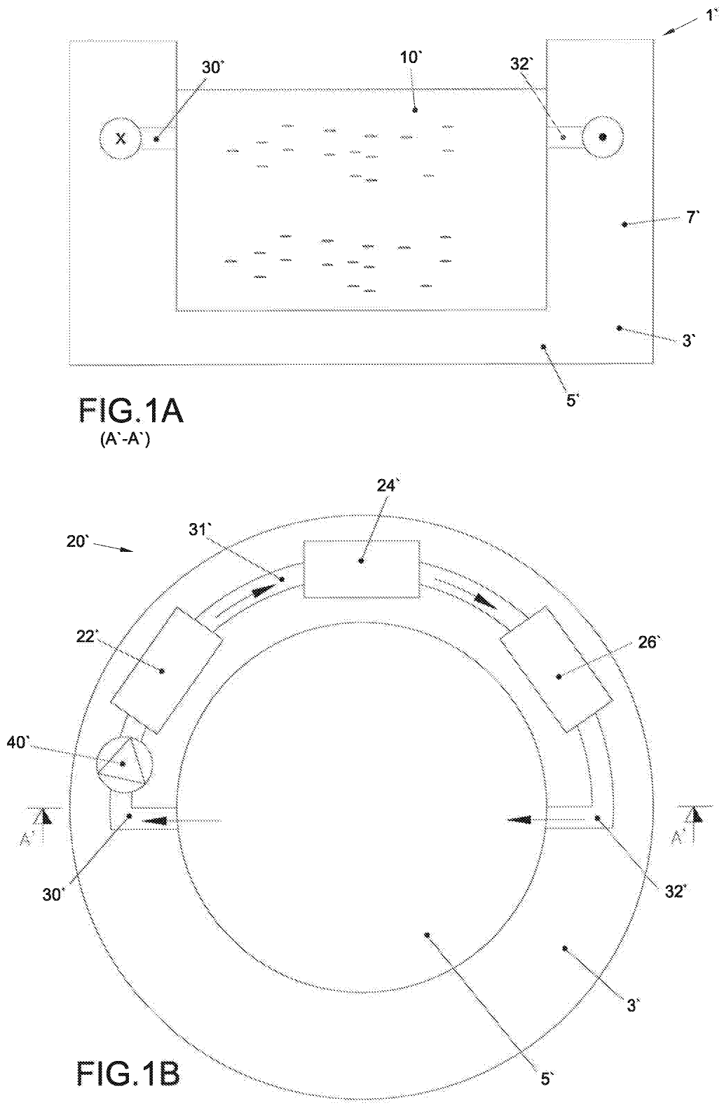

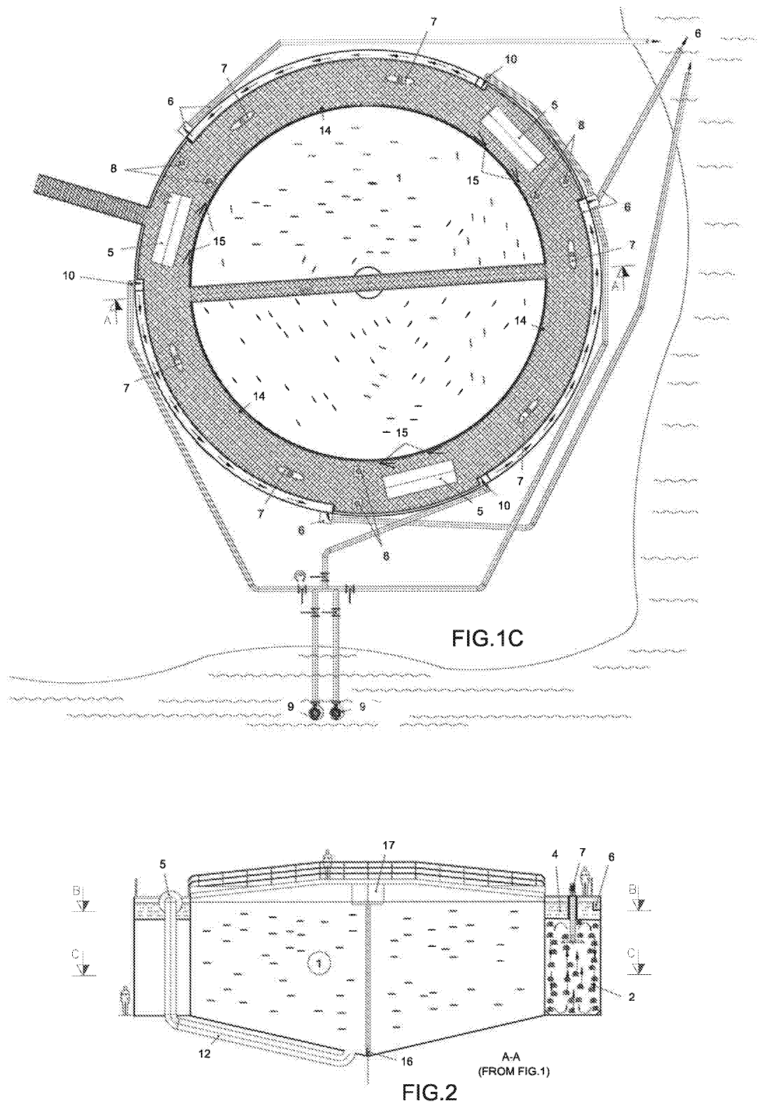

In FIGS. 1A and 1B schematic views of a container arrangement 1′ for fish farming according to an embodiment of the invention are disclosed. The container arrangement 1′ comprises a body 3′ comprising a bottom section 5′ and a wall section 7′ that define a volume adapted to receive water 10′ for the fish farming operation.

The container arrangement 1′ further comprises a water treatment arrangement 20′ for treatment of the water in the container arrangement 1′. The water treatment arrangement 20′ comprises a device 22′ for removal of solid particles from the water, a device 24′ for removal of CO2 from the water, and a device 26′ for providing oxygen to the water. The treatment arrangement 20′ is arranged in the body 3′ of the container arrangement 1′, in particular in the wall section 7′ of the body 1′.

In the disclosed embodiment, the devices 22′, 24′, 26′ of the water treatment arrangement 20′ are arranged in sequence after each other so to enable the inlet 30′ to provide a portion of the water directly from the volume of the container arrangement to the device 22′ for removal of solid particles. The device 22′ for removal of solid particles provides directly water to the device 24′ for removal of CO2 from the water. The device 24′ for removal of CO2 from the water provides directly water to the device 26′ for providing oxygen to the water.

It shall however be understood that the water treatment arrangement 20′ is not restricted to such combination but may comprise one or more of the device 22′, 24′, 26′. Furthermore, the devices 22′, 24′, 26′ may be arranged in a different sequence or their functions may be combined into one or more devices.

The water treatment arrangement 20′ is arranged extending along the periphery of the body 3′ of the container arrangement 1′. For purpose of illustration, the water treatment arrangement 20′ is only illustrated as extending along half of the periphery of the body 3′ of the container arrangement 1′. However, it shall be understood that the water treatment arrangement 20′ preferably maybe be arranged along the full length of the periphery of the body 3′ of the container arrangement 1. It shall be understood that the water treatment arrangement 20′ maybe be divided in two or more portions arranged in separate parts of the body 3′ of the container arrangement 1′.

The water treatment arrangement 20′ further comprises an inlet 30′ from the volume of the container arrangement and a channel 31′ to the devices 22′, 24′, 26′ of the water treatment arrangement 20′ and an outlet 32′ from the devices 22′, 24′, 26′ of the water treatment arrangement 20′ back to the volume of the container arrangement 1′. The devices 22′, 24′, 26′ are connected to each other between the inlet 30′ and outlet 32′.

In the disclosed embodiment, the inlet 30′ is directed from the volume of the container arrangement 1′ to the device 22′ for removal of solid particles. After treatment of the portion of the water by the device 22′ for removal of solid particles, the treated portion of the water is transferred to the device 24′ for removal of CO2. Correspondingly, after treatment of the portion of the water by the device 24′ for removal of CO2, the treated portion of the water is transferred to the device 26′ for providing oxygen to the water.

The water treatment arrangement 20′ further comprises a means 40′ for circulation of water from the inlet 30′ to the outlet 32′ passing through the connected devices 22′, 24′, 26′. The means for circulation of water is for example a pump, such as one of a positive displacement pump and a centrifugal pump.

After the portion of water has been treated by the water treatment arrangement 20′, the portion of the water is reintroduced to the volume of the container arrangement 1′ by means of the outlet 32′. In the disclosed embodiment of the invention, after treatment of the portion of the water by the device 26′ for providing oxygen, the portion of the water is transferred back to the volume of the of the container arrangement 1′ by means of the outlet 32′. In FIG. 1A, the direction of flow of the portion of the water in direction into the paper is illustrated with an ‘x’ next to the inlet 30′ and a flow in direction out of the paper is indicated with a ‘dot’ next to the outlet 32′. The direction of flow is also indicated by arrows in FIG. 1B.

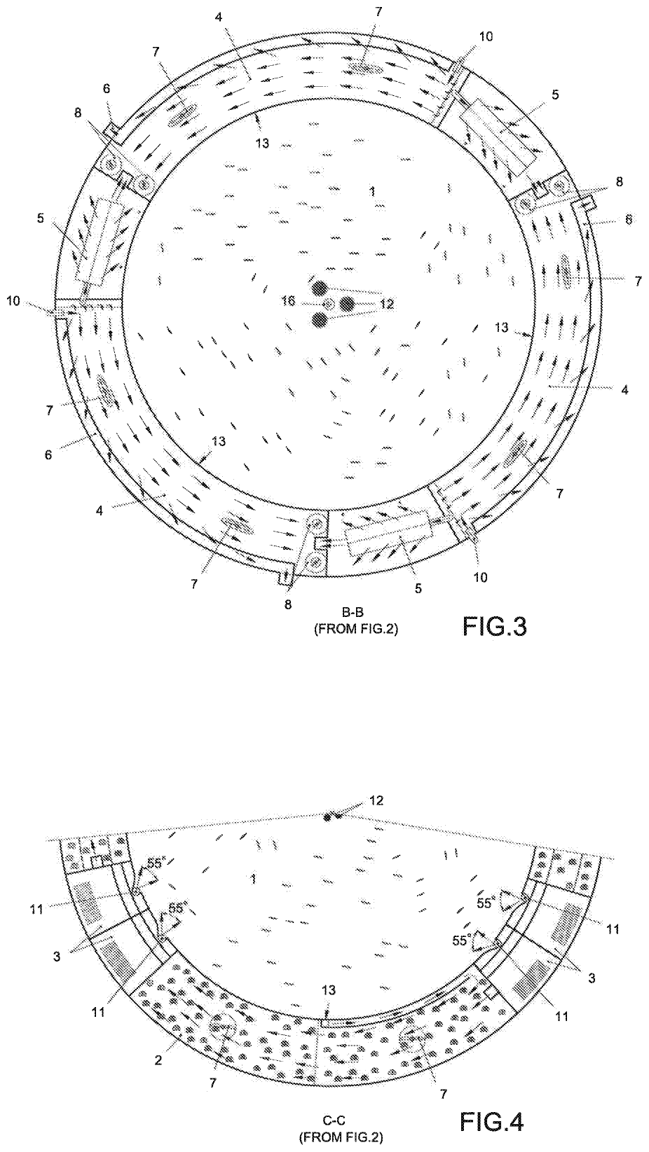

In FIG. 1C-7 different views of a container arrangement for fish farming according to a further embodiment of the invention are disclosed.

With reference to FIG. 1C-7, the container arrangement comprises a plurality of water treatment arrangements. The container arrangement comprises an inlet to a channel 12 to the water treatment arrangements. In the disclosed embodiment, the inlet is arranged at a lower portion of the container arrangement. The inlet is provided with a sieve 24 for preventing dead fish or other large objects to be introduced to the water treatment arrangement. The channel 12 is arranged within a wall section of the container arrangement with the exception at the lower portion of the container arrangement. The container arrangement comprises means for setting the water into motion within the channel 12. In the disclosed embodiment, the means for setting the water into motion comprises one or more propellers 7.

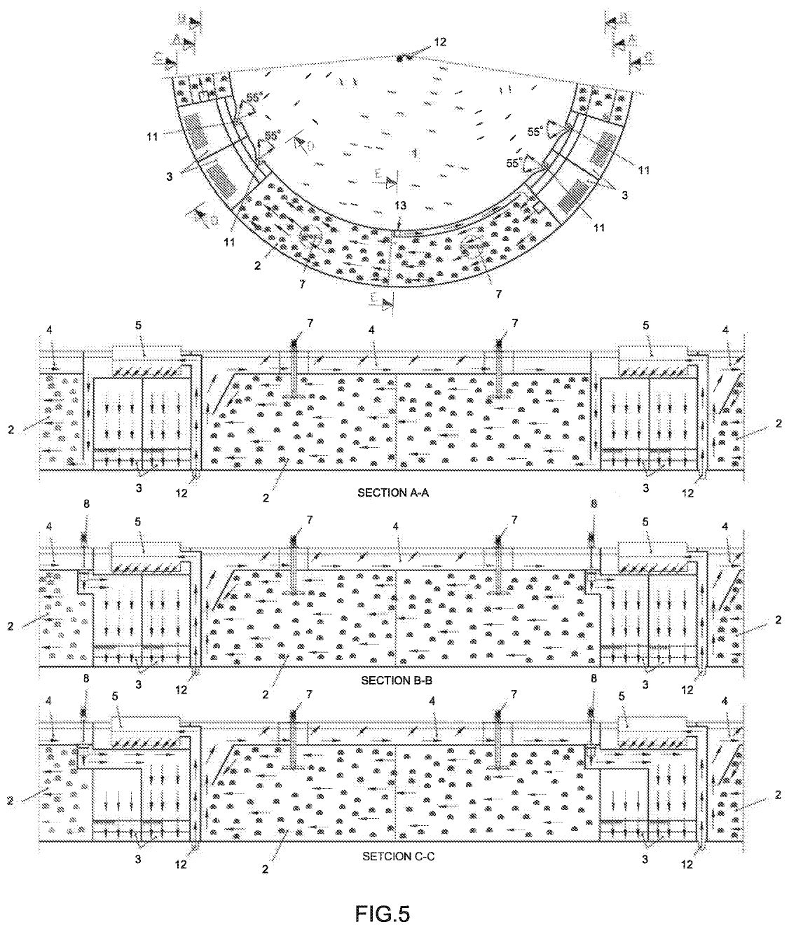

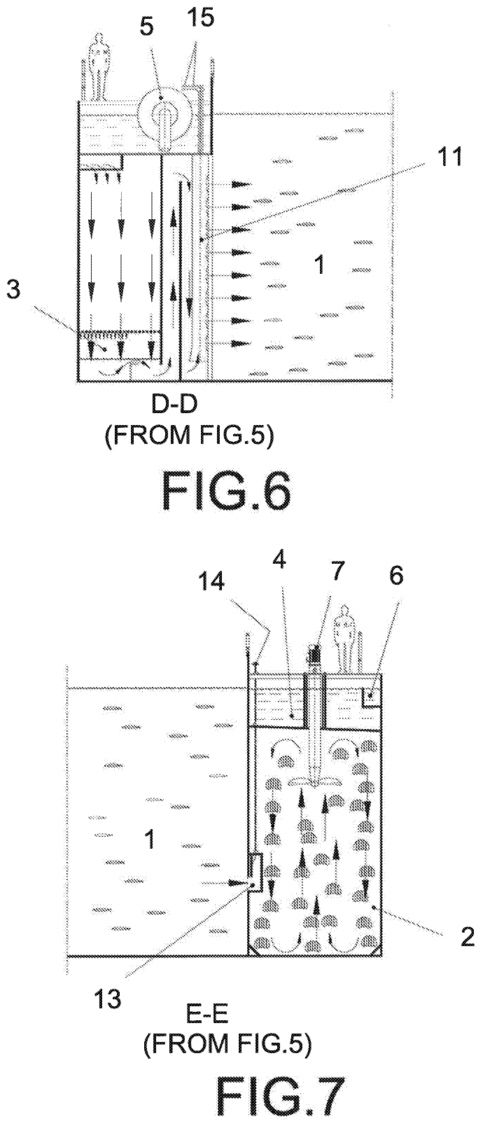

The water is first conducted from the inlet to a rotating filter 5, such as a drum filter, see FIG. 3. From the rotating filter 5, the water is conducted to a biofilter 2 for subjecting the water to biofiltration, see FIG. 5 section A-A. In the disclosed embodiment, the rotating filter 5 is arranged above the biofilter 2 and the oxygen chamber 3 within the wall section of the container arrangement.

From the rotating filter 5, the water is conducted through a channel to a bottom part of the biofilter 2. The biofilter 2 comprises two chambers separated by a perforated separation wall.

From the biofilter 2, the water is conducted to a channel for CO2 stripping (degassing) see FIG. 5 pos.4. The opening is adjusted by means of a valve arrangement 14, such as a sliding valve, see FIG. 1C. From the CO2 stripping channel 4, the water is pressurizing by pump 8 through the oxygen chamber 3, and jet nozzles through which the pressurized water is conducted. The inlet water flow from the oxygen chamber 3 can be adjusted from bottom to top of the chamber, and approx. 55°, from center of the container 1, see FIG. 5. pos.11, to the container wall. The adjustment of the flow is done at pos.15 in FIG. 6.

In the disclosed embodiment, the oxygen chamber 3 comprises two separate sub-chambers. After oxidation of the water, the water is reintroduced into the volume of the container arrangement. In the disclosed embodiment, after oxidation, the water is conducted by means of a further channel 11 in the wall of the container arrangement up and then down to the bottom portion of the container arrangement, where the water is reintroduced into the volume of the container arrangement by means of an inlet.

Furthermore, the container arrangement comprises means for introducing water from an outside of the container arrangement and means for discharging water from the volume of the container arrangement.

With reference to FIG. 1C, the container arrangement comprises one or more inlet pumps 9 for introducing water from an outside to the container arrangement. The container arrangement comprises a channel 4 for conducting the water to the water treatment arrangement. In FIG. 1C, the container arrangement further comprises one or more circulation pumps 10 for circulating the water received from the inlet pumps to the channel 4 for conducting the water to the water treatment arrangement.

In FIG. 1C-7, the following features are included: pool 1, aerating channel, outlet 6, propeller 7, new water pump 9, pool inlet 11, poolside outlet 13, adjustment pool inlet 15, dead fish collector 16 and dead fish tank 17.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

1.-10. (canceled)

11. A container arrangement for fish farming, the container arrangement comprises a body comprising a bottom section and a wall section that define a volume adapted to receive water for the fish farming, and a water treatment arrangement for treatment of the water in the container arrangement, wherein the water treatment arrangement comprises a device for removal of CO2 from the water of the container arrangement comprising a separation chamber for CO2 and means for separation of CO2 arranged at said chamber, wherein the water treatment arrangement is arranged in the wall section of the container arrangement.

12. The container arrangement according to claim 11, wherein the water treatment arrangement comprises an inlet to the separation chamber and an outlet from the separation chamber, which inlet, outlet and separation chamber are arranged at the elevation of said volume defined by the body of the container arrangement.

13. The container arrangement according to claim 12, wherein the inlet, outlet and separation chamber are arranged within the periphery defined by the body of the container arrangement.

14. The container arrangement according to claim 11, wherein the body of the container arrangement mainly comprises composite material with a strength adapted to contain the water and hold the water treatment arrangement in the body of the container arrangement.

15. The container arrangement according to claim 11, wherein the separation chamber of the device for removal of CO2 extends along a circumference of said wall section of the body of the container arrangement.

16. The container arrangement according to claim 11, wherein the water treatment arrangement comprises two or more devices for removal of CO2 chambers that are located in different parts of the wall section of the container arrangement.

17. The container arrangement according to claim 11, wherein the water treatment arrangement comprises a device for removal of solid particles from the water.

18. The container arrangement according to claim 11, wherein the water treatment arrangement comprises an inlet to the separation chamber and an outlet from the separation chamber, and wherein the water treatment arrangement comprises means for circulation of water from volume of the container arrangement by means of the inlet to the separation chamber and from the separation chamber to the outlet and back into the volume of the container arrangement.

19. The container arrangement according to claim 11, wherein the water treatment arrangement comprises a device for providing oxygen to the water.
